(19) United States
(12) Patent Application Publication
(10) Pub. No.: US 2020/0240641 A1
(43) Pub. Date: Jul. 30, 2020

(54) TURBOMACHINE, SUCH AS AN AIRCRAFT TURBOJET ENGINE

(71) Applicant: SAFRAN AIRCRAFT ENGINES, Paris (FR)

(72) Inventors: Catherine PIKOVSKY, MOISSY-CRAMAYEL (FR); Antoine Jean-Philippe BEAUJARD, MOISSY-CRAMAYEL (FR); Tewfik BOUDEBIZA, MOISSY-CRAMAYEL (FR)

(21) Appl. No.: 16/775,412

(22) Filed: Jan. 29, 2020

(30) Foreign Application Priority Data
Jan. 29, 2019 (FR) 1900811

(51) Int. Cl. F23R 3/28; F02C 3/04; F02C 7/18; F02C 7/22

(52) U.S. Cl. CPC F23R 3/28; F02C 3/04; F05D 2240/12; F02C 7/22; F05D 2220/323; F02C 7/18

(57) ABSTRACT

The invention relates to a turbomachine (1), such as an aircraft turbojet or turboprop, extending along an axis (X), comprising a primary flow jet (2) comprising at least one compressor (4, 5), at least one combustion chamber (6) and at least one turbine (7, 8), and a secondary flow jet (3) located radially outside the primary flow jet (2), at least one duct (18) for the flow of cooling air, said duct (18) comprising an air inlet opening into the primary flow jet (2), at the compressor (4, 5), and an air outlet opening into the primary flow jet (2), at the turbine (7, 8).

### CROSS-REFERENCE TO RELATED APPLICATION

This application claims priority to French Patent Application No. 1900811, filed Jan. 29, 2019, which is incorporated herein by reference.

### Technical Field of the Invention

The present invention relates to a turbomachine, such as an aircraft turbojet engine or a turboprop engine.

### Prior Art

The invention relates in particular to a low-bypass turbomachine. Of course, the invention is not limited to such an application.

The airframe of an action for a low-bypass engine classically comprises a turbomachine mounted in a generally cylindrical housing opening at the rear of the fuselage. Such a structure 22 is for example known from document FR 3 008 152 in the name of the Applicant.

The turbomachine comprises a flow jet of a primary flow or primary flow jet comprising, in the downstream direction, i.e. in the flowing direction of the gas flow inside the turbomachine, at least one compressor, at least one combustion chamber and at least one turbine, and a flow jet of a secondary flow or secondary flow jet located radially outside the primary flow jet. The secondary flow jet is bounded externally by a radially outer shroud. The terms axial and radial are defined relative to the X axis.

An annular space is formed between the radially outer shroud of the turbomachine and the wall delimiting the housing in which the turbomachine is mounted.

The turbomachine further comprises a duct extending into the secondary flow jet and intended for the flow of cooling air, said duct comprising an air inlet opening into the primary flow jet, at the compressor, and an air outlet opening into the primary flow jet, at the turbine. The air from the compressor is thus directed to the turbine, in particular the so-called high-pressure turbine, located directly downstream of the combustion chamber, in order to ensure its cooling.

Such a structure is known for instance from document FR 2 879 649. The disadvantage of such a structure is that the presence of the cooling duct in the secondary flow jet penalizes the flow of the secondary flow jet as well as the section of said secondary flow jet, and therefore the bypass rate that can be obtained with the aid of such a turbomachine.

As a reminder, the bypass rate is the ratio between the air flow rate of the secondary flow jet and that of the primary flow jet.

### SUMMARY OF THE INVENTION

The invention aims to remedy such drawback in a simple, reliable and inexpensive way. For this purpose, the invention provides a turbomachine, such as an aircraft turbojet or turboprop, extending along an axis, comprising a flow jet of a primary flow or primary flow jet comprising at least one compressor, at least one combustion chamber and at least one turbine, and a flow jet of a secondary flow or secondary flow jet located radially outside the primary flow jet, at least one duct for the flow of cooling air, said duct comprising an air inlet opening into the primary flow jet, at the compressor, and an air outlet opening into the primary flow jet, at the level of the turbine, characterized in that it comprises at least one first arm and at least one second arm located downstream of the first arm with respect to the flowing direction of the secondary flow, each arm being hollow and extending radially into the secondary flow jet, the duct having an upstream portion comprising the air inlet and extending at least in part into the first arm, a middle portion extending outside the secondary flow jet, and a downstream portion comprising the air outlet, extending at least in part into the second arm.

In this way, part of the cooling duct is located radially outside the secondary flow jet, so as to limit, in particular, disturbances to the secondary flow and so as to be cooled by the air circulating between the secondary flow of the turbomachine and the airframe of the aircraft. In the case of a turbomachine equipping a low bypass aircraft, said part situated outside the secondary flow jet can be housed in the annular channel situated between the outer shroud externally delimiting the secondary flow jet and the wall delimiting the cylindrical housing in which the turbomachine is housed.

As a reminder, the bypass rate is the ratio between the air mass of the secondary or cold flow and that of the primary or hot flow. In the context of the invention, the bypass rate is, for example, between 0.1:1 and 1:1.

The turbomachine may have an annular fairing extending around the compressor and internally delimiting the secondary flow jet.

The fairing limits the aeraulic disturbances during the flowing of the secondary flow. The fairing can be attached, at least in part, to the first arm.

Each arm may have a profiled section.

The arms can be located axially opposite each other.

The upstream portion of the cooling duct may have a portion extending axially in the secondary flow jet and a portion extending radially in the first arm.

The downstream portion of the duct can extend radially and can extend integrally into the second arm.

The turbomachine may comprise means for injecting fuel into the combustion chamber and a kerosene supply duct supplying said fuel injection means, said kerosene supply duct being housed, at least in part, in the first arm.

The compressor may have at least one variable pitch stator impeller.

The invention will be better understood and other details, characteristics and advantages of the invention will appear when reading the following description, which is given as a non-limiting example, with reference to the attached drawings.

### BRIEF DESCRIPTION OF THE FIGURES

FIG. 1 is an axial cross-sectional view of a part of the turbomachine according to the invention.

FIG. 2 is a schematic view showing the cross-section of one of the arms.

### DETAILED DESCRIPTION OF THE INVENTION

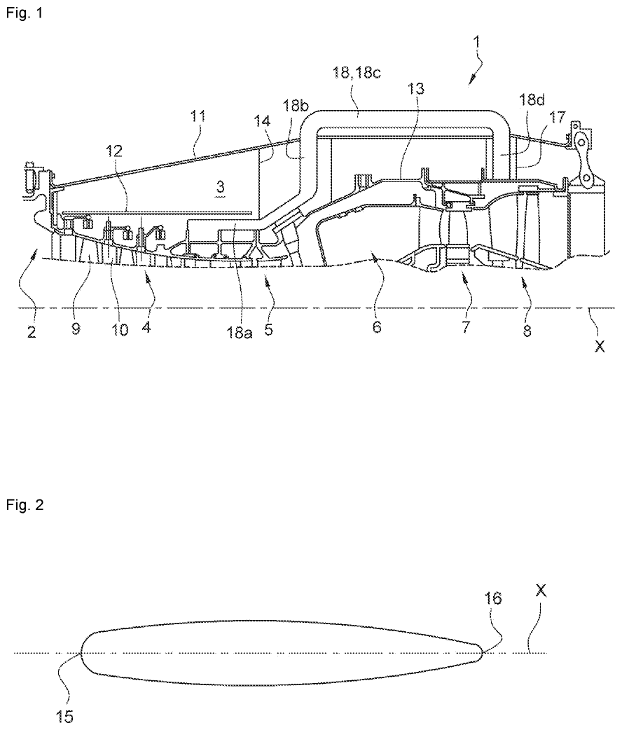

FIG. 1 shows a turbomachine 1 according to an embodiment of the invention. This extends along an X axis and comprises a flow jet of a primary flow 2, called the primary flow jet, and a flow jet of a secondary flow 3, called the secondary flow jet.

The turbomachine 2 has, in the downstream direction, i.e. in the flowing direction inside the turbomachine 1, a low-pressure compressor 4, a high-pressure compressor 5, a combustion chamber 6, a high-pressure turbine 7 and a low-pressure turbine 8.

The low-pressure and high-pressure compressors 4, 5 have alternating rotor blade impellers 9 and stator blade impellers 10. The blades of the stator 10 impellers are of the variable pitch type. The structure of such blades is known per se. The rotor of the low-pressure compressor 4 is driven in rotation by the rotor of the low-pressure turbine via a first shaft. The rotor of the high-pressure compressor 5 is driven in rotation by the rotor of the high-pressure turbine 7 via a second shaft.

The secondary flow jet 3 is annular and surrounds the primary flow jet 2. The primary flow jet 2 is delimited, radially on the outside, by a radially external annular shroud 11. The secondary flow jet 3 is bounded, radially inside, by an annular shroud 12 surrounding the low-pressure compressor 4 and the high-pressure compressor 5 and by one or more casing(s) 13 surrounding the combustion chamber 6 and the high-pressure and low-pressure turbines 7, 8. A first radial arm 14 extends radially in the secondary flow jet 3, between the combustion chamber casing 13 and the outer shroud 11. The first arm 14 is hollow and has a profiled section as shown in FIG. 2. Said section has an upstream leading edge 15 and a downstream trailing edge 16 and has an axially symmetrical tapered shape.

The fairing 12 is attached at its downstream end to the first arm 14.

A second radial arm 17 extends radially in the secondary flow jet 3, between the combustion chamber casing 13 and the outer shroud 11, downstream of the first arm 14. The second arm 17 is hollow and has a profiled section similar to that of the first arm 14. The first arm 14 and the second arm 17 are positioned axially opposite one another.

The turbomachine 1 also has a coolant flow duct 18 connecting the low-pressure compressor 4 and/or the high-pressure compressor 5 to the high-pressure turbine 7. In particular the duct 18 has an upstream portion 18a extending from the low-pressure compressor 4 and/or the high-pressure compressor 5 to the first arm 14. Said upstream portion 18a extends radially inside the fairing 12, and is therefore not located in the secondary flow jet 3. The upstream portion enters the first arm 14 through an opening located in the radially internal portion of the arm 14. The upstream portion 18a of the duct 18 is then extended by a portion 18b extending radially into the first arm 14 and opening radially outside the outer shroud 11, for example in the annular channel delimited between the turbomachine 1 and the airframe of an aircraft equipped with a low bypass engine. The duct 18 thus comprises a median portion 18c extending axially outside the outer shroud 11, and therefore the secondary flow jet 3, extended by a downstream portion 18d extending radially in the second arm 17 and opening at the high-pressure turbine 7.

In this way, the presence of the cooling duct 18 does not affect the flow of the secondary flow, said duct 18 allowing the taking of air from the low-pressure compressor 4 and/or the high-pressure compressor 5 to ensure the cooling of the high-pressure turbine 7.

A fuel supply duct feeding combustion chamber injectors can also be accommodated, at least in part, in the first arm.

1. A turbomachine, such as a turbojet, extending along an axis, comprising a primary flow jet comprising at least one compressor, at least one combustion chamber and at least one turbine, and a secondary flow jet located radially outside the primary flow jet, at least one duct for the flow of cooling air, said duct comprising an air inlet opening into the primary flow jet at the compressor, and an air outlet opening into the primary flow jet, at the turbine, characterized in that it comprises at least one first arm and at least one second arm located downstream of the first arm with respect to the flowing direction of a secondary flow in the secondary flow jet, each arm being hollow and extending radially in the secondary flow jet, the duct having an upstream portion comprising the air inlet and extending at least partly in the first arm, a middle portion extending outside the secondary flow jet, and a downstream portion comprising the air outlet, extending at least partly in the second arm.

2. A turbomachine according to claim 1, characterized in that it comprises an annular fairing extending around the compressor and internally delimiting the secondary flow jet.

3. A turbomachine according to claim 2, characterised in that the fairing is attached, at least in part, to the first arm.

4. A turbomachine according to claim 1, characterized in that each arm has a profiled section.

5. A turbomachine according to claim 2, characterized in that each arm has a profiled section.

6. A turbomachine according to claim 3, characterized in that each arm has a profiled section.

7. A turbomachine according to claim 1, characterized in that the upstream portion of the duct comprises a portion extending axially in the secondary flow jet and a portion (extending radially in the first arm.

8. A turbomachine according to claim 2, characterized in that the upstream portion of the duct comprises a portion extending axially in the secondary flow jet and a portion (extending radially in the first arm.

9. A turbomachine according to claim 3, characterized in that the upstream portion of the duct comprises a portion extending axially in the secondary flow jet and a portion (extending radially in the first arm.

10. A turbomachine according to claim 4, characterized in that the upstream portion of the duct comprises a portion extending axially in the secondary flow jet and a portion (extending radially in the first arm.

11. A turbomachine according to claim 1, characterized in that the downstream portion of the duct extends radially and extends integrally into the second arm.

12. A turbomachine according to claim 2, characterized in that the downstream portion of the duct extends radially and extends integrally into the second arm.

13. A turbomachine according to claim 7, characterized in that the downstream portion of the duct extends radially and extends integrally into the second arm.

14. A turbomachine according to claim 1, characterized in that it comprises means for injecting fuel into the combustion chamber and a kerosene supply duct supplying said fuel injection means, said kerosene supply duct being housed, at least in part, in the first arm.

15. A turbomachine according to claim 2, characterized in that it comprises means for injecting fuel into the combustion chamber and a kerosene supply duct supplying said fuel injection means, said kerosene supply duct being housed, at least in part, in the first arm.

16. A turbomachine according to claim 7, characterized in that it comprises means for injecting fuel into the combustion chamber and a kerosene supply duct supplying said fuel injection means, said kerosene supply duct being housed, at least in part, in the first arm.

17. A turbomachine according to claim 1, characterized in that the compressor has at least one stator blade wheel with variable stator pitch.

18. A turbomachine according to claim 2, characterized in that the compressor has at least one stator blade wheel with variable stator pitch.

19. A turbomachine according to claim 7, characterized in that the compressor has at least one stator blade wheel with variable stator pitch.
